(19) United States
(12) Patent Application Publication
(10) Pub. No.: US 2026/0288671 A1
(43) Pub. Date: Sep. 24, 2026

(54) SERIAL COMMUNICATION COLLISION ABATEMENT HARDWARE

(71) Applicant: Haier US Appliance Solutions, Inc., Wilmington, DE (US)

(72) Inventors: Mark Anthony Didat, Floyds Knobs, IN (US); Ryan Michael Hartlage, Crestwood, KY (US); Steven Michael Recio, Louisville, KY (US); Nathaniel Lehrer, Louisville, KY (US)

(21) Appl. No.: 19/082,531

(22) Filed: Mar. 18, 2025

(51) Int. Cl. G06F 13/42

(52) U.S. Cl. CPC G06F 13/4282; G06F 13/36; G06F 13/376; G06F 2213/0002

(57) ABSTRACT

A serial communication system is provided. The serial communication system includes a communication bus having a half-duplex topology. The serial communication system further includes a first controller configured to communicate with one or more second controllers via the communication bus. The serial communication system further includes a collision management circuit operably coupled to an enable pin of the first controller and the communication bus, the collision management circuit configured to provide a bus busy signal to the enable pin of the first controller based at least in part on a state of the communication bus. The first controller is configured to transmit data onto the communication bus based at least in part on the bus busy signal.

### FIELD

Example aspects of the present disclosure relate generally to collision abatement hardware for a communication system of an appliance, and more specifically to collision abatement hardware for a serial communication bus having a half-duplex bus topology.

### BACKGROUND

Domestic appliances are utilized for a variety of domestic tasks such as cooking food, drying laundry, or tasks. Such appliances may utilize multiple nodes having controllers that are in communication with one another. In some instances, these controllers may communicate with one another over a shared communication bus.

### SUMMARY

Aspects and advantages of embodiments of the present disclosure will be set forth in part in the following description, or can be learned from the description, or can be learned through practice of the embodiments.

One example embodiment of the present disclosure is directed to a serial communication system. The serial communication system includes a communication bus having a half-duplex topology. The serial communication system further includes a first controller configured to communicate with one or more second controllers via the communication bus. The serial communication system further includes a collision management circuit operably coupled to an enable pin of the first controller and the communication bus, the collision management circuit configured to provide a bus busy signal to the enable pin of the first controller based at least in part on a state of the communication bus. The first controller is configured to transmit data onto the communication bus based at least in part on the bus busy signal.

Another example embodiment of the present disclosure is directed to a method for transmitting serial data onto a communication bus having a half-duplex bus topology. The method includes determining, by a collision management circuit, a bus busy signal indicative of a state of the communication bus. The method further includes providing, by the collision management circuit, the bus busy signal to an enable pin of a controller. The method further includes transmitting, by a transmit pin of the controller, data onto the communication bus via a transmit line based at least in part on the bus busy signal.

Another example embodiment of the present disclosure is directed to a control system for an appliance. The control system includes a communication bus having a half-duplex bus topology. The control system further includes a plurality of nodes communicatively coupled to the communication bus. One or more nodes of the plurality of nodes include a controller. The one or more nodes of the plurality of nodes further include a collision management circuit operably coupled to an enable pin of the controller and the communication bus, the collision management circuit configured to provide a bus busy signal to the enable pin of the controller based at least in part on a state of the communication bus. The controller is configured to transmit data onto the communication bus based at least in part on the bus busy signal.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example appliance according to example embodiments of the present disclosure;

FIG. 2 depicts an example communication system according to example embodiments of the present disclosure.

FIG. 3 depicts a schematic implementation of an example communication node according to example embodiments of the present disclosure;

FIG. 4 depicts a schematic implementation of another example communication node according to example embodiments of the present disclosure;

FIG. 5A depicts a schematic implementation of an example collision detection circuit according to example embodiments of the present disclosure;

FIG. 5B provides a graphical representation of example signals of the collision detection circuit of FIG. 5A;

FIG. 6A depicts a schematic implementation of another example collision detection circuit according to example embodiments of the present disclosure;

FIG. 6B provides a graphical representation of example signals of the collision detection circuit of FIG. 6A;

FIG. 7 provides a block diagram of an example controller according to example embodiments of the present disclosure; and

FIG. 8-9 provide an example method for transmitting serial data onto a communication bus according to example aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Some serial communication bus topologies may employ collision abatement functionality such as collision management and collision detection through complex and process intensive software routines that may significantly reduce data throughput. Furthermore, industry standards such as controller area network (CAN) bus protocols may call for more expensive components (e.g., controllers) to provide effective anti-collision functionality. In addition, some serial communication bus topologies may communicate using an open drain architecture, which may limit data speed and node distance. For instance, open drain bus architectures may create challenges when implementing a communication between off-board nodes over a harness (e.g., harness charger) due to bit rounding and/or electromagnetic interference (EMI) susceptibility coupled through harness parasitics. Alternatively, some communication systems may utilize differential signals with industry standards such as RS-485 or by abandoning bus architecture for full duplex point-to-point options such as UART or SPI.

Example aspects of the present disclosure provide for collision management with UART based options to perform collision abatement in hardware, thereby alleviating at least some of this burden from software. Systems and methods provided herein provide for a push-pull bus architecture, which may allow for robust signal integrity and off-board, multi-node serial communication. In addition, aspects of the present disclosure provide for voltage and current based collision detection to detect bus collision events.

Aspects of the present disclosure provide for multiple technical effects and benefits. For example, systems and methods provided herein may allow for robust signal integrity and off board multi-node serial communication while enabling the use of cost-effective system components (e.g., controllers). In addition, the collision management circuits and collision detection circuits of the present disclosure may mitigate intensive software burdens by providing a cost-effective hardware solution with effective anti-collision functionality.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Referring now to the figures, example aspects of the present disclosure will be discussed in greater detail.

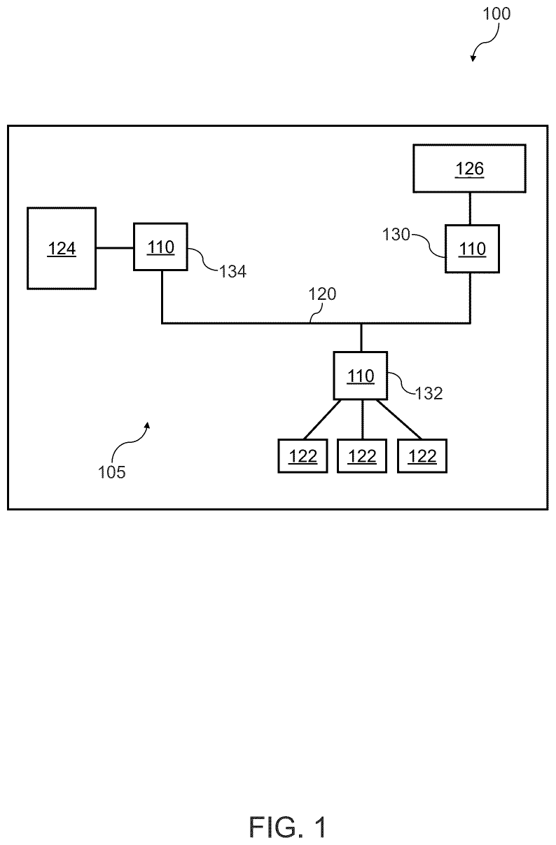

FIG. 1 provides a block diagram of an example appliance 100 according to example embodiments of the present disclosure. Appliance 100 may be any suitable appliance. For instance, appliance 100 may be a domestic appliance, such as a refrigerator, a dishwasher, a microwave oven, a cooktop, an oven, a washing machine, a dryer, a water heater, a water filter or purifier, an air conditioner, a space heater, or any other household appliance.

Appliance 100 may include a control system 105 configured to, for instance, control operations of appliance 100. Specifically, control system 105 may include a plurality of controllers 110. FIG. 1 depicts three controllers 110 for purposes of illustration and discussion. Those of ordinary skill in the art will understand that control system 105 may include any suitable number of controllers 110 without deviating from the scope of the present disclosure.

As shown in FIG. 1, each controller 110 may be configured to interface with one or more components of appliance 100. For instance, one or more controllers 110 may be configured to control operations of a user interface 126 of the appliance 100. In addition, one or more other controllers 110 may be configured to interface with one or more sensors 122 of the appliance 100. In addition, one or more other controllers 110 may be configured to control operations of another component 124 (e.g., solenoid valve, compressor, drive motor, etc.) of appliance 100.

In some embodiments, controllers 110 may be positioned at various locations within the appliance such that one or more controllers 110 are spaced apart from other controllers 110. As such, the plurality of controllers 110 may be configured to communicate with one another over a communication bus 120. For instance, each controller 110 of control system 105 may correspond to an individual node 130, 132, 134 (e.g., communication node). Each node 130, 132, 134 may be communicatively coupled to one or more other nodes 130, 132, 132 via communication bus 120 such that each node 130, 132, 134 may be operable to transmit and/or receive data from other nodes 130, 132, 134 via communication bus 120.

Specifically, communication bus 120 may be a serial communication bus having a single wire. For instance, communication bus 120 may include a singular wire such that each communication node 130, 132, 134 may transmit and/or receive data via a shared channel. The shared channel may enable a single node 130, 132, 134 to transmit data at one time. For instance, a collision event may occur if more than one node 130, 132, 134 is transmitting data simultaneously. Accordingly, control system 105 may include one or more collision management circuit(s) and/or one or more collision detection circuit(s) as described below.

Additionally, communication bus 120 may be a half-duplex serial communication bus having a half-duplex bus topology. For instance, communication bus 120 may be configured for two-way communication, such that each node 130, 132, 134 may transmit and receive data via communication bus 120.

In some embodiments, nodes 130, 132, 134 may employ Universal Asynchronous Receiver/Transmitter (UART) based communication. For instance, each node 130, 132, 134 may include a transmit line and a receive line operably coupled to communication bus 120. This may allow for a controller 110 employing a UART protocol to communicate over serial communication bus 120 (e.g., single wire communication bus 120). Specifically, the transmit line may operably couple a transmit pin of a controller 110 to the communication bus 120, while the receive line may operably couple a receive pin of the same controller 110 to the communication bus 120.

Communication nodes 130, 132, 134 may be communicatively coupled to the communication bus 120. For instance, communication nodes 130, 132, 134 may be configured to communicate via communication bus 120 using a push-pull bus architecture (e.g., half-duplex push-pull bus architecture). For example, a transmit line of each node 130, 132, 134 may be switched from a high impedance state to a transmit state prior to a data transmission event. Upon completion of the data transmission event, the transmit line may be returned to the high impedance state. As used herein, a high impedance state or receive state may be defined as a signal state of a controller pin in which the controller pin is not driving a signal (e.g., signal is left open), such that other nodes communicatively coupled to the communication bus may drive the shared signal.

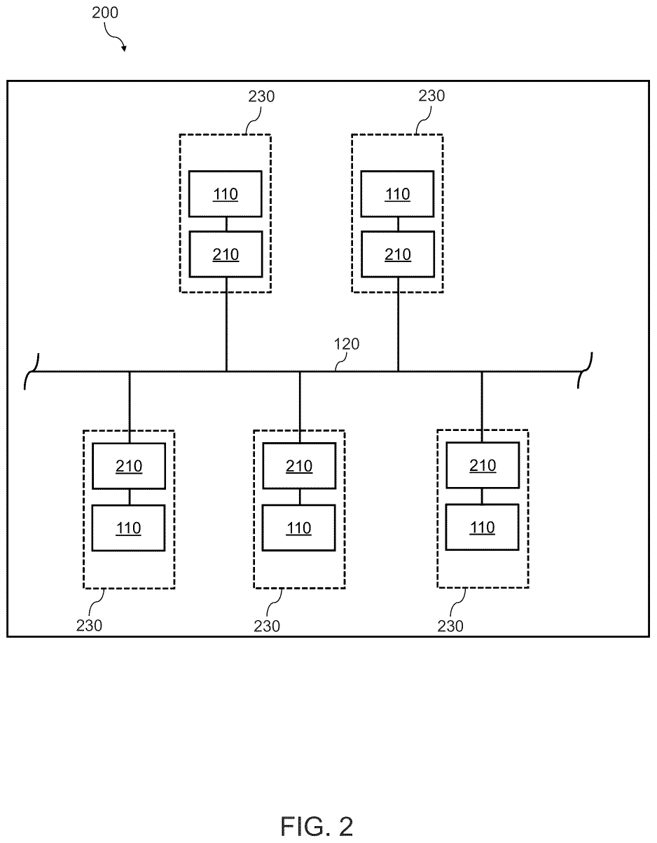

Referring now to FIG. 2, an example communication system 200 according to example embodiments of the present disclosure is provided. Communication system 200 can be implemented in a control system for an appliance, such as in control system 105 of FIG. 1.

Communication system 200 includes a plurality of nodes 230 (e.g., communication nodes) configured to communicate with one another via communication bus 120 (e.g., shared communication bus). Communication bus 120 may be a serial communication bus, such as a half-duplex serial communication bus having a half-duplex bus topology. As shown, communication bus 120 may include a singular wire such that each communication node 230 may transmit and/or receive data via a shared channel. The shared channel may enable a single node 230 to transmit data at one time. For instance, a collision event may occur if more than one node 230 is transmitting data simultaneously. In some embodiments, communication system 200 may include one or more collision detection circuit(s) as described below.

In some embodiments, communication nodes 230 are configured to communicate using a push-pull bus architecture (e.g., half-duplex push-pull bus architecture). For instance, each communication node 230 may be coupled to communication bus 120 via a corresponding transmit line. Each transmit line may be switched from a high impedance state to a transmit state prior to a data transmission event. Upon completion of the data transmission event, the transmit line may be returned to the high impedance state.

As shown in FIG. 2, each node may include a controller 110 and a collision management circuit 210. Specifically, each controller 110 may be operably coupled to communication bus 120 via a collision management circuit 210. Collision management circuits 210 are configured to provide collision abatement functionality to communication system 200. For instance, communication system 200 may be configured such that a single node 230 may transmit data onto communication bus 120 at one time. Accordingly, each collision management circuit 210 may be configured to manage data transmission from a corresponding controller 110 onto the communication bus 120 based on a state of the communication bus 120. For instance, a collision management circuit 210 may provide a bus busy signal to a corresponding controller 110 based on a state of the communication bus 120. The controller 110 may then transmit data onto the communication bus 120 based at least in part on the bus busy signal.

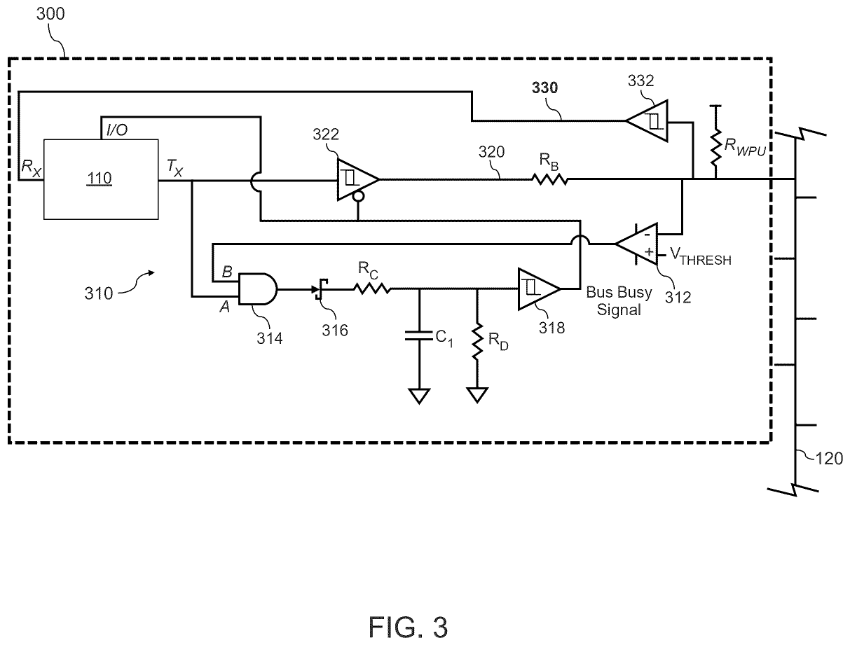

FIG. 3 depicts a schematic implementation of an example communication node 300 communicatively coupled to a communication bus 120. As shown, node 300 may include a controller 110 and a collision management circuit 310. Node 300 and/or collision management circuit 310 may be implemented in a communication system, such as communication system 200 of FIG. 2. Additionally and/or alternatively, node 300 and/or collision management circuit 310 may be implemented in a control system of an appliance, such as control system 105 of appliance 100 as shown in FIG. 1.

As shown in FIG. 3, controller 110 may communicate serial data via a Universal Asynchronous Receiver Transmitter (UART) style protocol such that controller 110 may receive data via a receive pin (R_{X}) and transmit data via a transmit pin (T_{X}). For instance, controller 110 may be configured to transmit data onto communication bus 120 (e.g., to one or more other controllers) via a transmit line 320. In addition, controller 110 may be configured to receive data from communication bus 120 (e.g., from one or more other controllers) via a receive line 330. Specifically, transmit line 320 may operably couple a transmit pin (T_{X}) of the controller 110 to the communication bus 120 while receive line 330 may operably couple a receive pin (R_{X}) of controller 110 to the communication bus 120. In some embodiments, a Schmitt buffer 332 (e.g., Schmitt trigger) may be placed between the receive pin (R_{X}) and the communication bus 120.

In some embodiments, communication node 300 may include a pull-up resistor (R_{WPU}) positioned between both the transmit line 320 and receive line 330 and the communication bus 120. The pull-up resistor (R_{WPU}) may be a weak pull-up resistor operable to hold the bus in a high state when no communication node is actively driving the communication bus 120. For instance, pull-up resistor (R_{WPU}) may have a resistance greater than about 20 kiloohms (kΩ).

As shown in FIG. 3, collision management circuit 310 may be configured to provide a bus busy signal to the controller 110 (e.g., enable pin (I/O) of controller 110). Collision management circuit 310 may provide the bus busy signal based at least in part on a state of the communication bus 120. Accordingly, collision management circuit 310 may be coupled to controller 110 and communication bus 120. Specifically, collision management circuit 310 may be coupled to an enable pin (I/O) of controller 110. In some embodiments, collision management circuit 310 may also be coupled to the communication bus 120 via the transmit line 320.

Transmit pin (T_{X}) of controller 110 may be controlled at least in part by the bus busy signal received at the enable pin (I/O). For instance, node 300 may be configured to communicate over communication bus 120 using a push-pull bus architecture. As such, a state of transmit line 320 may be controlled (e.g., switched) based on the bus busy signal.

Collision management circuit 310 may include a comparator 312 configured to compare a voltage on the communication bus 120 to a threshold voltage (e.g., bus busy threshold voltage). In some embodiments, the communication bus voltage may be sampled between pull-up resistor (R_{WPU}) and a resistor (R_{B}) positioned in series (e.g., along transmit line 320). Resistor (R_{B}) may be for short circuit protection and have a resistance of, for instance, about 100 ohms (Ω). Specifically, comparator 312 may output high when the voltage on the communication bus 120 is less than the threshold voltage. In some embodiments, the bus busy threshold voltage may be to accommodate the number of nodes in the network (e.g., nodes commutatively coupled to communication bus 120). Additionally and/or alternatively, the resistance value of resistor (R_{B}) may be adjusted to based on the number of nodes in the network to, for instance, reduce bus stiffness. For instance, the busy threshold may be set to about 4 volts (V) while the resistance value of resistor (R_{B}) may be set to about 100 ohms (Ω) when the network includes 5 communication nodes.

The output of comparator 312 may be provided as an input (e.g., input B) to AND gate 314 of the collision management circuit 310. The transmit pin (T_{X}) of controller 110 may provide the other input (e.g., input A) to AND gate 314. For instance, controller 110 as shown in FIG. 3 may initiate a transmission event by transmitting data via the transmit pin (T_{X}). Accordingly, a transmission event may be indicated by input A of AND gate 314. If a transmission event is indicated (e.g., Transmit pin (T_{X}) is high) and the bus is busy (e.g., voltage on bus 120 is less than the bus busy threshold voltage), AND gate 314 may output the bus busy signal (e.g., output high) to the enable pin (I/O).

In some embodiments, the bus busy signal may also be provided to a switching component 322 such as a tri-state buffer. Switching component 322 may disconnect the controller 110 (e.g., transmit pin (T_{X}) of controller 110) from the communication bus 120 based at least in part on the bus busy signal. For instance, when provided with the bus busy signal (e.g., output high), switching component 322 may turn to an off state, disconnecting the transmit pin (T_{X}) from the communication bus 120 such that data may not be transmitted and a collision event is avoided. The off state of switching component 322 may correspond to a high impedance state of transmit line 320.

In some embodiments, switching component 322 may be maintained in the off state for a set amount of time (e.g., disconnect time (τ_{D})) corresponding to the amount of time the bus busy signal is provided. Specifically, the disconnect time (τ_{D}) may be set in hardware as the disconnect time (τ_{D}) may be equal to the resistance value of resistor (R_{D}) multiplied by the capacitance value of capacitor (C₁). For instance, the respective values of resistor (R_{D}) and capacitor (C₁) may be configured such that the disconnect time (τ_{D}) is greater than 10/B_{D}, where BD is the baud rate used for communicating over the communication bus 120. Additionally, the disconnect time (τ_{D}) may be reset (e.g., restarted) on any ‘0’ bit or by a subsequent start bit. For instance, the first node of the communication system/control system to transmit a ‘0’ may be allowed to transmit while all other nodes of the system may be disabled for a time greater than one byte.

After the bus returns to the high state (e.g., not busy) for the duration of the disconnect time (τ_{D}), the bus busy signal may no longer be provided. When the busy signal is no longer provided (e.g., after the disconnect time (τ_{D}) has passed), switching component 322 may then reconnect the transmit pin (T_{X}) to the communication bus 120 such that controller 110 may transmit data to one or more other controllers via communication bus 120.

In some embodiments, collision management circuit 310 may further include additional circuit components to, for instance, process the bus busy signal. For instance, AND gate 314 may output the bus busy signal to a Schottky diode 316. The collision management circuit 310 may further include a resistor (R_{C}) having a small resistance value in series with the Schottky diode 316. Additionally and/or alternatively, collision management circuit 310 may include capacitor (C₁) and resistor (R_{D}) which may be tuned for time delay. In some embodiments, collision management circuit 310 may further include a Schmitt buffer 318 (e.g., Schmitt trigger) configured to provide the bus busy signal to a switching component 322 and/or the enable pin (I/O).

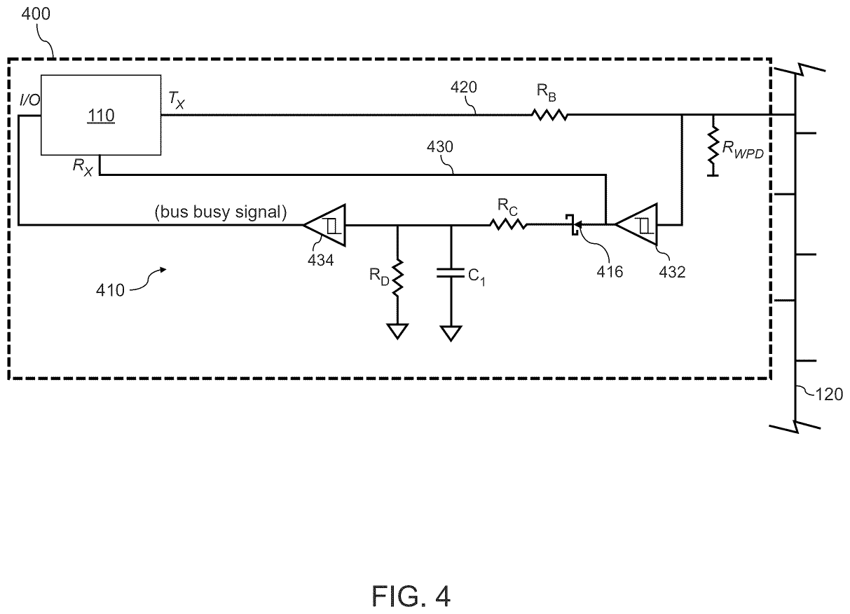

Referring now to FIG. 4, another example communication node 400 communicatively coupled to a communication bus 120 is provided according to example embodiments of the present disclosure. As shown, node 400 may include a controller 110 and a collision management circuit 410. Node 400 and/or collision management circuit 410 may be implemented in a communication system, such as communication system 200 of FIG. 2. Additionally and/or alternatively, node 400 and/or collision management circuit 410 may be implemented in a control system of an appliance, such as control system 105 of appliance 100 as shown in FIG. 1.

As shown in FIG. 4, controller 110 may communicate serial data via a Universal Asynchronous Receiver Transmitter (UART) style protocol such that controller 110 may receive data via a receive pin (R_{X}) and transmit data via a transmit pin (TX). For instance, controller 110 may be configured to transmit data onto communication bus 120 (e.g., to one or more other controllers) via a transmit line 420. In addition, controller 110 may be configured to receive data from communication bus 120 (e.g., from one or more other controllers) via a receive line 430. Specifically, transmit line 420 may operably couple a transmit pin (T_{X}) of the controller 110 to the communication bus 120 while receive line 430 may operably couple a receive pin (R_{X}) of controller 110 to the communication bus 120.

As shown in FIG. 4, communication node 400 may include a pull-down resistor (R_{WPD}) coupled to communication bus 120 and a resistor (R_{B}) positioned in series (e.g., along transmit line 420). Resistor (R_{B}) may be for short circuit protection and have a resistance of, for instance, about 100 ohms (Ω). Pull-down resistor (R_{WPD}) may be a weak pull-down resistor operable to set the bus in a low state when no communication node is actively driving the communication bus 120. For instance, pull-down resistor (R_{WPU}) may have a resistance greater than about 20 kiloohms (kΩ).

Collision management circuit 410 may be configured to provide a bus busy signal to the controller 110 (e.g., enable pin (I/O) of controller 110). Collision management circuit 410 may provide the bus busy signal based at least in part on a state of the communication bus 120. Accordingly, collision management circuit 410 may be coupled to controller 110 and communication bus 120. Specifically, collision management circuit 410 may be coupled to an enable pin (I/O) of controller 110.

Collision management circuit 410 may sample (e.g., determine) a voltage on communication bus 120. For instance, collision management circuit 410 may be operably coupled to communication bus 120 via transmit line 420, such as between resistor (R_{B}) and pull-down resistor (R_{WPD}) as shown in FIG. 4. In some embodiments, collision management circuit 410 may receive an input from communication bus 120 through a first Schmitt buffer 432 (e.g., Schmitt trigger) and provide the bus busy signal to controller 110 through a second Schmitt buffer 434 (e.g., Schmitt trigger).

In some embodiments, collision management circuit 410 may further include additional circuit components to, for instance, process the bus busy signal. For instance, Schmitt buffer 432 may output to a Schottky diode 416. The collision management circuit 310 may further include a resistor (R_{C}) having a small resistance value in series with the Schottky diode 416. Additionally and/or alternatively, collision management circuit 310 may additionally include capacitor (C₁) and resistor (R_{D}) which may be tuned for time delay.

In some embodiments, receive line 430 may couple controller 110 to collision management circuit 410 (e.g., between the first Schmitt buffer 432 and Schottky diode 416) such that controller 110 may receive data from communication bus 120 via the first Schmitt buffer 432.

Transmit pin (T_{X}) of controller 110 may be controlled at least in part by the bus busy signal received at the enable pin (I/O). For instance, node 400 may be configured to communicate over communication bus 120 using a push-pull bus architecture. For instance, controller 110 may include internal circuitry operable to set transmit pin (T_{X}) in a transmit state or a receive state (e.g., high impedance state). Controller 110 may further be configured to set the state of the transmit pin (T_{X}) based on the bus busy signal received at the enable pin (I/O). Accordingly, a state of the transmit line 420 may be set based on the state of transmit pin (T_{X}). As such, a state of transmit line 420 may be controlled (e.g., switched) based on the bus busy signal received at the enable pin (I/O).

In some embodiments, controller 110 may be configured to keep transmit pin (T_{X}) (e.g., transmit line 420) in a high impedance state when the controller is not actively transmitting (e.g., until a transmission event). For instance, controller 110 may be configured to sample the bus busy signal provided at the enable pin (I/O) prior to a transmission event. If the sampled bus busy signal indicates that the communication bus 120 is not busy (e.g., no other controller is currently transmitting), controller 110 may switch the state of the transmit pin (T_{X}) (e.g., transmit line 420) from the high impedance state to a transmit state. When in the transmit state, transmit pin (T_{X}) may be configured to transmit data onto communication bus 120. In further embodiments, controller 110 may be configured to switch the state of the transmit pin (T_{X}) (e.g., transmit line 420) from the transmit state back to the high impedance state after the transmission event such that other controllers on communication bus 120 may then transmit data. In some embodiments, the collision management circuit 410 is configured to maintain the bus busy signal between bytes transmitted over communication bus 120.

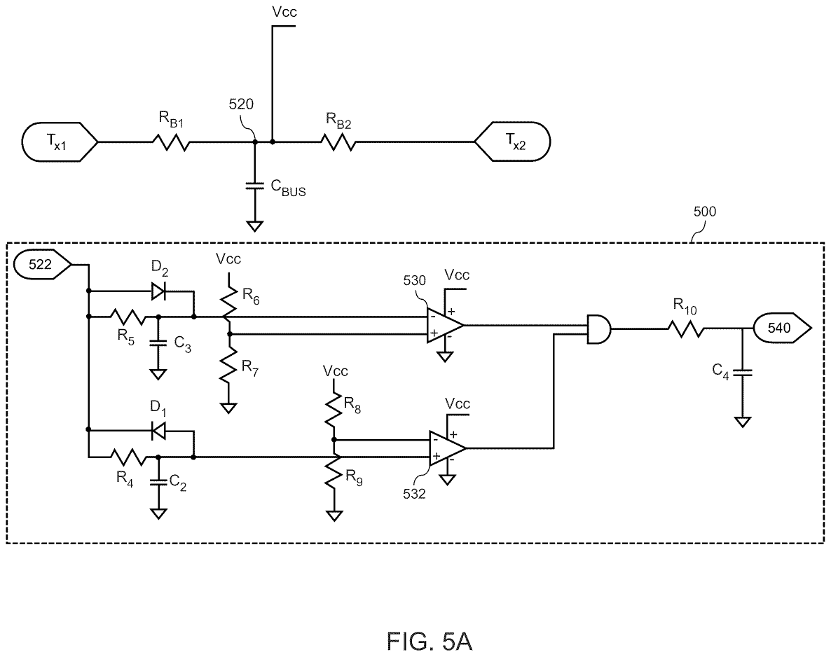

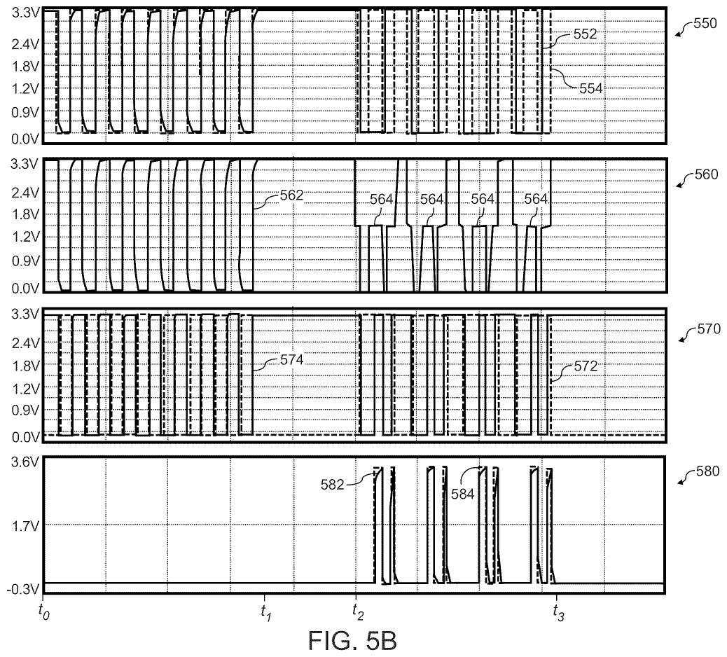

Referring now to FIG. 5A, an example collision detection circuit according to example embodiments of the present disclosure is provided. Collision detection circuit 500 may be implemented in a communication system, such as communication system 200 of FIG. 2. Additionally and/or alternatively, collision detection circuit 500 may be implemented in a control system of an appliance, such as control system 105 of appliance 100 as shown in FIG. 1.

Collision detection circuit 500 is configured to detect a bus collision event on a serial communication bus 520. Specifically, collision detection circuit 500 may determine a bus collision event based on a voltage level of the serial communication bus 520.

As such, collision detection circuit 500 may be coupled to a serial communication bus 520 between two communication nodes. For instance, referring back to FIG. 1, collision detection circuit 500 (FIG. 5A) may be coupled between node 130 and node 132 along communication bus 120. As such, collision detection circuit 500 may monitor and/or detect a collision event by sensing the voltage (e.g., voltage level) between the two nodes, such as between node 103 and 132.

As shown in FIG. 5A, collision detection circuit 500 may be operatively coupled to both a transmit pin of a first controller (T_{X1}) and a transmit pin of a second controller (T_{X2}) along communication bus 520. As shown, a common voltage supply (V_{CC}) may be coupled to communication bus 520. FIG. 5A further includes a capacitor (C_{BUS}) coupled to the communication bus 520 to model the bus capacitance and/or parasitic capacitance of the node (e.g., wire-to-wire capacitance). In addition, each transmit pin T_{X1}, T_{X2} is shown in FIG. 5A to be coupled to the communication bus 520 via a resistor (R_{B1} and R_{B2}). Resistors R_{B1} and R_{B2} are included in FIG. 5A to model the source impedance of the transmitters (e.g., transmit pins T_{X1}, T_{X2}) as well as any current limiting resistors places in series between the transmit pins (T_{X1}, T_{X2}) and the bus 520 (e.g., bus node).

Collision detection circuit 500 is configured to sense a bus voltage signal 522 indicating a voltage on communication bus 520. For instance, bus voltage signal 522 may be a buffered voltage signal of the voltage on communication bus 520. Collision detection circuit 500 may include a first resistor-capacitor (RC) filter circuit (e.g., resistor R₅ and capacitor C₃) and a second RC filter circuit (e.g., resistor R₄ and capacitor C₂). Each RC filter circuit may be configured to receive the bus voltage signal 522. Specifically, the RC filter having resistor R₅ and capacitor C₃ may include a diode (e.g., diode D₂) and the RC filter having resistor R₄ and capacitor C₂ may include a diode (e.g., diode D₁). As shown diode D₁ and diode D₂ may have opposite orientations relative to bus voltage signal 522.

The RC filter circuit (e.g., resistor R₅ and capacitor C₃) may be connected to comparator 530 as a negative edge input (e.g., negative-going input). Comparator 530 may compare the output of the RC filter circuit (e.g., resistor R₅ and capacitor C₃) to a threshold voltage set by, for instance, resistor R₆ and resistor R₇. Additionally, RC filter circuit (e.g., resistor R₄ and capacitor C₂) may be connected to comparator 532 as a positive edge input (e.g., positive going input). Comparator 532 may compare the output of the RC filter circuit (e.g., resistor R₄ and capacitor C₂) to a threshold voltage set by, for instance, resistor R₈ and resistor R₉. An AND gate 534 may be configured to receive the output of comparator 530 and the output of comparator 532 as inputs. AND gate 534 may output a collision detection signal 540 indicating that a collision event has occurred. In some embodiments, collision detection circuit 500 may further include additional circuitry, such as resistor R₁₀ and/or capacitor C₄, to, for instance, further process collision detection signal 540 such that collision detection signal 540 may be provided to a controller.

Referring now to FIG. 5B, a graphical representation of example signals of the collision detection circuit 500 of FIG. 5A is provided. Specifically, plots 550, 560, 570 ,580 provide example signals of the collision detection circuit 500 over an example time period (e.g., the same example time period). As shown in FIG. 5B, a first transmission event may occur from about t₀ to about t₁. In addition, a second transmission event may occur from about t₂ to about t₃.

Plot 550 provides example voltage signals 552, 554 of a first transmit pin (T_{X1}) and a second transmit pin (T_{X2}) on a serial communication bus 520. Specifically, voltage signal 552 indicates data transmitted onto the communication bus 520 by the transmit pin (T_{X1}) of a first controller, while voltage signal 554 indicates data transmitted onto the communication bus 520 by the transmit pin (T_{X2}) of a second controller. In addition, plot 560 provides a bus voltage signal 562 indicating a voltage of the communication bus over the example time period.

As shown, the first transmission event occurring from about t₀ to about t₁ may indicate a non-collision transmission event. Alternatively, the second transmission event (e.g., occurring from about t₂ to about t₃) may indicate a bus collision event on communication bus 520. For instance, bus voltage signal 562 may indicate a prolonged mid-rail voltage 564 due to voltage signals 552, 554.

Plot 570 provides an example negative threshold signal 572 and an example positive threshold signal 574. Specifically, negative threshold signal 572 may be the output of comparator 530 (FIG. 5A) while positive threshold signal 574 may be the output of comparator 532 (FIG. 5A).

As shown in plot 580, an example collision detection signal 582 may be determined based on the example negative threshold signal 572 and the example positive threshold signal 574. Specifically, collision detection signal 582 may be the output of AND gate 534 (FIG. 5A). As shown, collision detection circuit 500 may detect a bus collision event.

As previously described with reference to FIG. 5A, collision detection circuit 500 may include additional signal processing circuitry, such as resistor R₁₀ and/or capacitor C₄, to, for instance, further process a collision detection signal such that collision detection signal may be provided to a controller. Accordingly, processed collision detection signal 584 may be output from collision detection circuit 500 to be provided to, for instance, a controller.

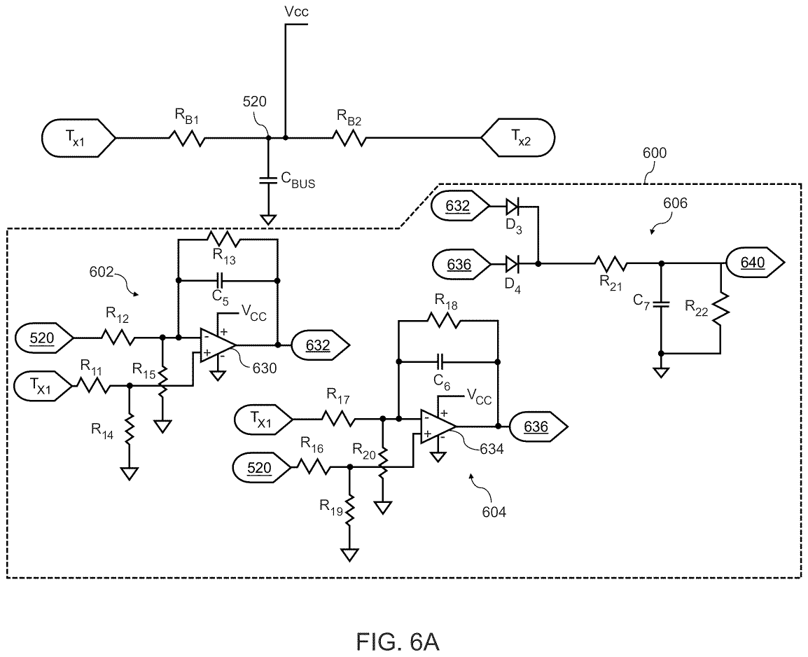

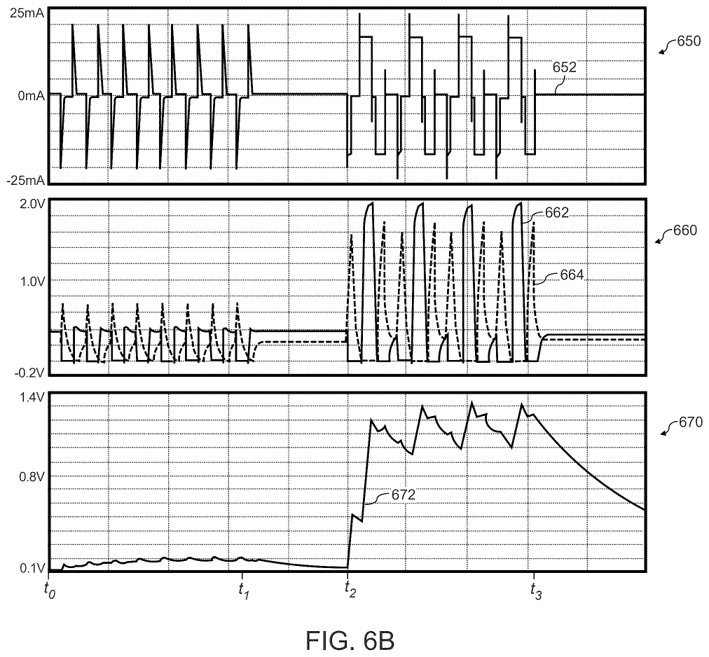

Referring now to FIG. 6A, another example collision detection circuit according to example embodiments of the present disclosure is provided. Collision detection circuit 600 may be implemented in a communication system, such as communication system 200 of FIG. 2. Additionally and/or alternatively, collision detection circuit 600 may be implemented in a control system of an appliance, such as control system 105 of appliance 100 as shown in FIG. 1.

Collision detection circuit 600 is configured to detect a bus collision event on a serial communication bus 520. Specifically, collision detection circuit 600 may determine a bus collision event based on a communication bus current of the serial communication bus 520.

As shown in FIG. 6A, collision detection circuit 600 may be operatively coupled to both a transmit pin of a first controller (T_{X1}) and a transmit pin of a second controller (T_{X2}) along communication bus 520. As shown, a common voltage supply (V_{CC}) may be coupled to communication bus 520. FIG. 6A further includes a capacitor (C_{BUS}) coupled to the communication bus 520 to model the bus capacitance and/or parasitic capacitance of the node (e.g., wire-to-wire capacitance). In addition, each transmit pin T_{X1}, T_{X2} is shown in FIG. 6A to be coupled to the communication bus 520 via a resistor (R_{B1} and R_{B2}). Resistors R_{B1} and R_{B2} are included in FIG. 6A to model the source impedance of the transmitters (e.g., transmit pins T_{X1}, T_{X2}) as well as any current limiting resistors places in series between the transmit pins (T_{X1}, T_{X2}) and the bus 520 (e.g., bus node).

Collision detection circuit 600 may include a first integrator circuit 602 and a second integrator circuit 604. Each integrator circuit 602, 604 may be coupled to the communication bus 520 and the first transmit pin (T_{X1}) of a controller such that resistor R_{B1} may act as a shunt resistor. A such, the voltage across resistor R_{B1} (e.g., shunt resistor R_{B1}) may correspond to (e.g., be proportional to) the current being pushed or pulled from the first transmit pin (T_{X1}).

First integrator circuit 602 may include an amplifier 630. The positive input of the amplifier 630 may be operably coupled to the transmit pin T_{X1}, while the communication bus 520 may be coupled to the negative input of amplifier 630. Specifically, negative input of amplifier 630 may be coupled to communication bus 520 at a node between R_{B1} and R_{B2}. First integrator circuit 602 may output a positive sensing signal 632 indicating a communication bus current in a first polarity (e.g., positive polarity).

Second integrator circuit 604 may include an amplifier 634. The negative input of the amplifier 634 may be operably coupled to the transmit pin T_{X1}, while the communication bus 520 may be coupled to the positive input of amplifier 634. Specifically, positive input of amplifier 634 may be coupled to communication bus 520 at a node between R_{B1} and R_{B2}. Second integrator circuit 604 may output a negative sensing signal 636 indicating a communication bus current in a second polarity (e.g., negative polarity).

The first integrator circuit 602 and second integrator circuit 604 may provide the positive sensing signal 632 and the negative sensing signal 636 to a summation circuit 606. Summation circuit 606 may include diodes D₃, D₄ configured to receive the positive sensing signal 632 and the negative sensing signal 636. Summation circuit 606 may also include a RC low pass (e.g., resistor R₂₁, capacitor C₇, and resistor R₂₂) operable to provide a collision detection signal 640 based on both the positive sensing signal 632 and the negative sensing signal 636 received from diodes D₃, D₄. In some embodiments, the resistance of resistor R₂₁ may be less than the resistance of resistor R₂₂.

Referring now to FIG. 6B, a graphical representation of example signals of the collision detection circuit 600 of FIG. 6A is provided. Specifically, plots 650, 660, 670 provide example signals of the collision detection circuit 600 over an example time period (e.g., the same example time period). As shown in FIG. 6B, a first transmission event may occur from about t₀ to about t₁. In addition, a second transmission event may occur from about t₂ to about t₃.

Plot 650 provides an example bus current signal 652 indicating an example current through communication bus 520. Plot 660 provides an example positive sensing signal 662 and the negative sensing signal 664. Specifically, positive sensing signal 662 may be provided by first integrator circuit 602 (FIG. 6A) and negative sensing signal 664 may be provided by second integrator circuit 604 (FIG. 6A).

As shown, the first transmission event occurring from about t₀ to about t₁ may indicate a non-collision transmission event. Alternatively, the second transmission event (e.g., occurring from about t₂ to about t₃) may indicate a bus collision event on communication bus 520. For instance, positive sensing signal 662 and/or negative sensing signal 664 may be greater during a collision event.

Plot 670 provides an example collision detection signal 672 of collision detection circuit 600. Example collision detection signal 672 may be provided by summation circuit 606. As shown, a collision event may occur when collision detection signal 672 is above a threshold. Specifically, collision detection signal 672 may be based on positive sensing signal 662 and the negative sensing signal 664, which are indicative of the communication bus current 652. As such, collision detection circuit 600 may be configured to determine a bus collision event based at least in part on a communication bus current 652.

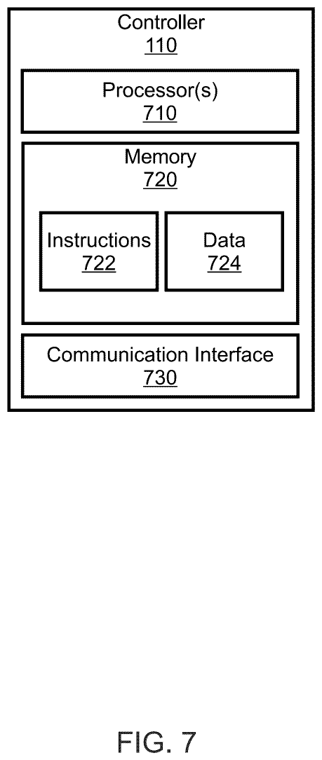

FIG. 7 provides a block diagram depicting an example controller 110 according to example embodiments of the present disclosure. Controller 110 may include one or more processor(s) 710. Processor(s) 710 may include any suitable processing device(s), such as one or more of a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, processor(s) 710 are not necessarily restricted to a single element but may include any suitable number, type, and configuration of processing devices integrated in any suitable manner to facilitate appliance operation. In alternative embodiments, controller 110 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 110 may further include, or be associated with, one or more memory devices 720. Memory devices 720 may include one or more memory elements or non-transitory computer-readable storage mediums, such as RAM, ROM, EEPROM, EPROM, flash memory devices, magnetic disks, or other suitable memory devices (including combinations thereof). Memory devices 720 may be a separate component from the processor(s) 710 or may be included onboard within the processor(s) 710. In addition, memory devices 720 can store information or data accessible by the one or more processors 710, including instructions 722 that can be executed by the one or more processors 710. It should be appreciated that the instructions 722 can be software written in any suitable programming language or can be implemented in hardware. Additionally, or alternatively, the instructions 722 can be executed logically or virtually using separate threads on the one or more processors 710.

For example, controller 110 may be operable to execute programming instructions or micro-control code associated with an operating mode of appliance 100 (FIG. 1). In this regard, the instructions 722 may be software or any set of instructions 722 that when executed by the one or more processor(s) 710, cause the one or more processor(s) 710 to perform operations, such as running one or more software applications, displaying a user interface, receiving user input, processing user input, etc. Moreover, it should be noted that controller 110 as disclosed herein is capable of and may be operable to perform any methods, method steps, or portions of methods as disclosed herein. For example, in some embodiments, methods disclosed herein may be embodied in programming instructions 722 stored in the memory devices 720 and executed by controller 110.

In some embodiments, memory devices 720 may also store data 724 that can be retrieved, manipulated, created, or stored by the one or more processors 710 of controller 110. The data 724 can include, for instance, data to facilitate performance of methods described herein. The data 724 can be stored locally (e.g., on controller 110) in one or more databases or may be split up so that the data 724 is stored in multiple locations. In addition, or alternatively, the one or more database(s) can be connected to controller 110 through any suitable network(s), such as through a high bandwidth local area network (LAN) or wide area network (WAN). In this regard, for example, controller 110 may further include a communication interface 730 that may be used to communicate with one or more other component(s) of appliance 100 (FIG. 1), controller 110, an external appliance controller, or any other suitable device, e.g., via any suitable communication lines or network(s) and using any suitable communication protocol.

Additionally and/or alternatively, communication interface 730 can include any suitable components for interfacing with one or more network(s), including for example, transmitters, receivers, ports, controllers, antennas, or other suitable components. For example, controller 110 may include an enable pin (I/O), a transmit pin (TX), and a receive pin (RX) as depicted in FIGS. 3 and 4.

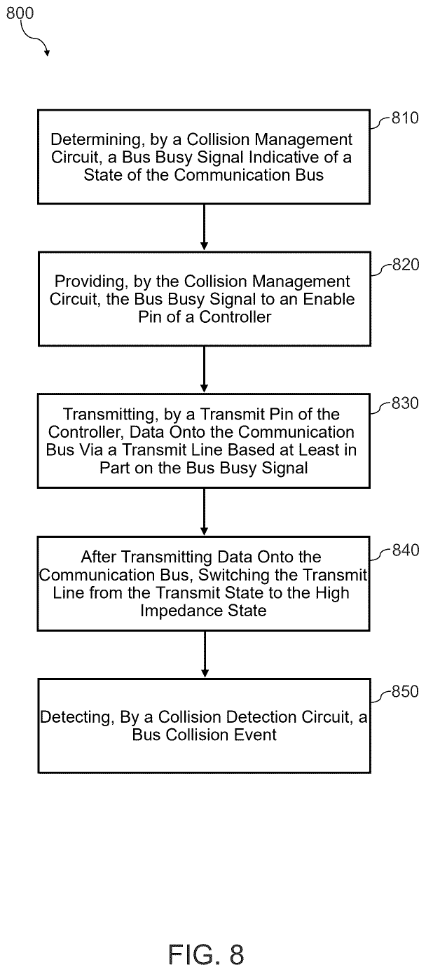

FIG. 8 provides an example method 800 for transmitting serial data onto a communication bus according to example aspects of the present disclosure. Method 800 may be performed by a control system for an appliance, such as control system 105 of Appliance 100 depicted in FIG. 1 or by a serial communication system, such as communication system 200 depicted in FIG. 2. In some embodiments, various method steps of method 800 may be performed (e.g., in whole or in part) by controller 110. It is noted that the order of steps within method 800 is for illustrative purposes. Except as otherwise indicated, one or more steps in method 800 may be changed, rearranged, performed in a different order, or otherwise modified without deviating from the scope of the present disclosure.

While method 800 is generally described with reference to communication node 400 depicted in FIG. 4, those of ordinary skill in the art will understand that method 800 may be performed by other communication nodes described herein, such as communication node 300 of FIG. 3.

As shown in FIG. 8, method 800 may include, at step 810, determining, by a collision management circuit, a bus busy signal indicative of a state of the communication bus. For example, collision management circuit 410 may determine the bus busy signal based at least in part on a state of communication bus 120.

Method 800 may further include, at step 820, providing, by the collision management circuit, the bus busy signal to an enable pin of a controller. For example, collision management circuit 410 may include a Schmitt buffer 434 (e.g., Schmitt trigger) operable to provide the bus busy signal to controller 110.

Method 800 may further include, at step 830, transmitting, by a transmit pin of the controller, data onto the communication bus via a transmit line based at least in part on the bus busy signal. For instance, a transmit pin (TX) of controller 110 may be configured to transmit data (e.g., serial data) onto communication bus 120 via transmit line 420 based at least in part on the bus busy signal.

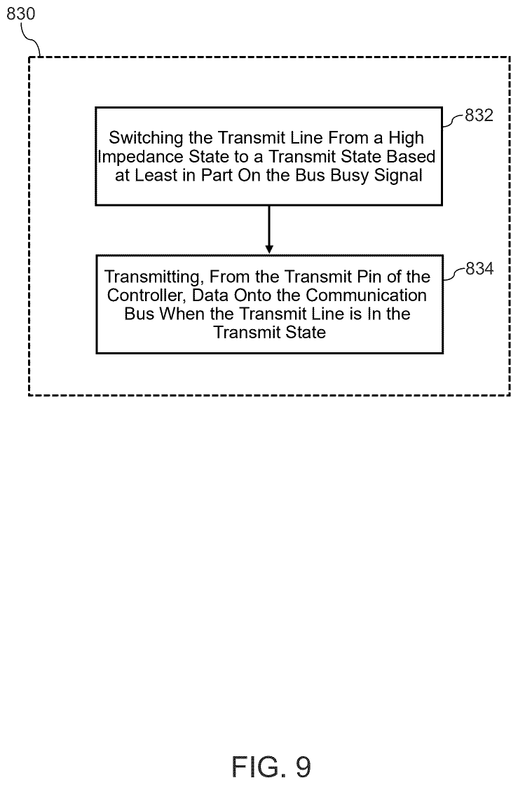

In some embodiments, transmitting data onto the communication bus as described with reference to step 830 of method 800 may include various sub-steps. For instance, FIG. 9 provides one or more steps 832, 834 that may be included in step 830 of method 800.

As shown in FIG. 9, step 830 of method 800 may include, at step 832, switching the transmit line from a high impedance state to a transmit state based at least in part on the bus busy signal. For example, controller 110 may include internal circuitry operable to switch transmit pin (T_{X}) from a high impedance state to a transmit state based on the bus busy signal provided by the collision management circuit 410.

Referring still to FIG. 9, step 830 of method 800 may further include, at step 834, transmitting, from the transmit pin of the controller, data onto the communication bus when the transmit line is in the transmit state. For example, controller 110 may be configured to transmit data onto communication bus 120 when the transmit line 420 is in the transmit state.

Now referring back to FIG. 8, in some embodiments, method 800 may further include, at step 840, after transmitting data onto the communication bus, switching the transmit line from the transmit state to the high impedance state. For instance, controller 110 may be configured to switch the state of the transmit pin (T_{X}) and/or transmit line 420 from the transmit state back to the high impedance state after the transmission event such that other controllers on communication bus 120 may then transmit data.

In some embodiments, method 800 may further include, at step 850, detecting, by a collision detection circuit, a bus collision event. For example, collision detection circuit 500 of FIG. 5 or collision detection circuit 600 of FIG. 6 may be configured to detect a bus collision event on a communication bus, such as communication bus 120.

One example embodiment of the present disclosure is directed to a serial communication system. The serial communication system includes a communication bus having a half-duplex topology. The serial communication system further includes a first controller configured to communicate with one or more second controllers via the communication bus. The serial communication system further includes a collision management circuit operably coupled to an enable pin of the first controller and the communication bus, the collision management circuit configured to provide a bus busy signal to the enable pin of the first controller based at least in part on a state of the communication bus. The first controller is configured to transmit data onto the communication bus based at least in part on the bus busy signal.

In some examples, the first controller is further configured to transmit data to the one or more second controllers via a transmit line operably coupling the communication bus to a transmit pin of the first controller.

In some examples, the serial communication system further includes a switching component coupled between the transmit pin and the communication bus, the switching component configured to switch the transmit line from a high impedance state to a transmit state based at least in part on the bus busy signal provided to the switching component.

In some examples, the collision management circuit is configured to control the switching component to switch the transmit line from the high impedance state to the transmit state based at least in part on the state of the communication bus and a data transmission provided by the transmit pin the first controller.

In some examples, the first controller is configured to switch the transmit line from a high impedance state to a transmit state prior to a transmission event of the first controller based at least in part on the bus busy signal.

In some examples, the first controller is further configured to switch the transmit line from the transmit state to the high impedance state after the transmission event of the first controller.

In some examples, the first controller is further configured to receive data from the one or more second controllers via a receive line operably coupling the communication bus to a receive pin of the first controller.

In some examples, the serial communication system further includes a collision detection circuit coupled to the communication bus, the collision detection circuit configured to detect a bus collision event.

In some examples, the collision management circuit is configured to provide the bus busy signal based at least in part on a voltage level of the communication bus.

Another example embodiment of the present disclosure is directed to a method for transmitting serial data onto a communication bus having a half-duplex bus topology. The method includes determining, by a collision management circuit, a bus busy signal indicative of a state of the communication bus. The method further includes providing, by the collision management circuit, the bus busy signal to an enable pin of a controller. The method further includes transmitting, by a transmit pin of the controller, data onto the communication bus via a transmit line based at least in part on the bus busy signal.

In some examples, transmitting data onto the communication bus includes switching the transmit line from a high impedance state to a transmit state based at least in part on the bus busy signal, and transmitting, from the transmit pin of the controller, data onto the communication bus when the transmit line is in the transmit state.

In some examples, the method further includes after transmitting data onto the communication bus, switching the transmit line from the transmit state to the high impedance state.

In some examples, the controller is configured to receive data via a receive line operably coupling the communication bus to a receive pin of the controller.

In some examples, the collision management circuit is configured to provide the bus busy signal based at least in part on a voltage level of the communication bus.

In some examples, the method further includes detecting, by a collision detection circuit, a bus collision event.

Another example embodiment of the present disclosure is directed to a control system for an appliance. The control system includes a communication bus having a half-duplex bus topology. The control system further includes a plurality of nodes communicatively coupled to the communication bus. One or more nodes of the plurality of nodes include a controller. The one or more nodes of the plurality of nodes further include a collision management circuit operably coupled to an enable pin of the controller and the communication bus, the collision management circuit configured to provide a bus busy signal to the enable pin of the controller based at least in part on a state of the communication bus. The controller is configured to transmit data onto the communication bus based at least in part on the bus busy signal.

In some examples, the control system further includes a collision detection circuit operably coupled to the communication bus, the collision detection circuit configured to detect a bus collision event.

In some examples, the collision detection circuit is configured to determine the bus collision event based at least in part on a voltage level of the communication bus.

In some examples, the collision detection circuit is configured to determine the bus collision event based at least in part on a communication bus current.

In some examples, the one or more nodes of the plurality of nodes further include a transmit line operably coupling a transmit pin of the controller to the communication bus and a receive line operably coupling a receive pin of the controller to the communication bus. In some examples, the transmit line is switched from a high impedance state to a transmit state based at least in part on the bus busy signal.

Although specific features of various embodiments may be shown in some drawings and not in others, this is for convenience only. In accordance with the principles of the present disclosure, any feature of a drawing can be referenced and/or claimed in combination with any feature of any other drawing.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A serial communication system comprising:
a communication bus having a half-duplex bus topology;
a first controller configured to communicate with one or more second controllers via the communication bus; and
a collision management circuit operably coupled to an enable pin of the first controller and the communication bus, the collision management circuit configured to provide a bus busy signal to the enable pin of the first controller based at least in part on a state of the communication bus,
wherein the first controller is configured to transmit data onto the communication bus based at least in part on the bus busy signal.

2. The serial communication system of claim 1, wherein the first controller is further configured to transmit data to the one or more second controllers via a transmit line operably coupling the communication bus to a transmit pin of the first controller.

3. The serial communication system of claim 2, further comprising:
a switching component coupled between the transmit pin and the communication bus, the switching component configured to switch the transmit line from a high impedance state to a transmit state based at least in part on the bus busy signal provided to the switching component.

4. The serial communication system of claim 3, wherein the collision management circuit is configured to control the switching component to switch the transmit line from the high impedance state to the transmit state based at least in part on the state of the communication bus and a data transmission provided by the transmit pin the first controller.

5. The serial communication system of claim 2, wherein the first controller is configured to switch the transmit line from a high impedance state to a transmit state prior to a transmission event of the first controller based at least in part on the bus busy signal.

6. The serial communication system of claim 5, wherein the first controller is further configured to switch the transmit line from the transmit state to the high impedance state after the transmission event of the first controller.

7. The serial communication system of claim 2, wherein the first controller is further configured to receive data from the one or more second controllers via a receive line operably coupling the communication bus to a receive pin of the first controller.

8. The serial communication system of claim 1, further comprising:
a collision detection circuit coupled to the communication bus, the collision detection circuit configured to detect a bus collision event.

9. The serial communication system of claim 1, wherein the collision management circuit is configured to provide the bus busy signal based at least in part on a voltage level of the communication bus.

10. A method for transmitting serial data onto a communication bus having a half-duplex bus topology, the method comprising:
determining, by a collision management circuit, a bus busy signal indicative of a state of the communication bus;
providing, by the collision management circuit, the bus busy signal to an enable pin of a controller; and
transmitting, by a transmit pin of the controller, data onto the communication bus via a transmit line based at least in part on the bus busy signal.

11. The method of claim 10, wherein transmitting data onto the communication bus comprises:
switching the transmit line from a high impedance state to a transmit state based at least in part on the bus busy signal; and
transmitting, from the transmit pin of the controller, data onto the communication bus when the transmit line is in the transmit state.

12. The method of claim 11, further comprising:
after transmitting data onto the communication bus, switching the transmit line from the transmit state to the high impedance state.

13. The method of claim 11, wherein the controller is configured to receive data via a receive line operably coupling the communication bus to a receive pin of the controller.

14. The method of claim 10, wherein the collision management circuit is configured to provide the bus busy signal based at least in part on a voltage level of the communication bus.

15. The method of claim 10, further comprising:
detecting, by a collision detection circuit, a bus collision event.

16. A control system for an appliance, comprising:
a communication bus having a half-duplex bus topology; and
a plurality of nodes communicatively coupled to the communication bus, one or more nodes of the plurality of nodes comprising:
a controller; and
a collision management circuit operably coupled to an enable pin of the controller and the communication bus, the collision management circuit configured to provide a bus busy signal to the enable pin of the controller based at least in part on a state of the communication bus,
wherein the controller is configured to transmit data onto the communication bus based at least in part on the bus busy signal.

17. The control system of claim 16, further comprising:
a collision detection circuit operably coupled to the communication bus, the collision detection circuit configured to detect a bus collision event.

18. The control system of claim 17, wherein the collision detection circuit is configured to determine the bus collision event based at least in part on a voltage level of the communication bus.

19. The control system of claim 17, wherein the collision detection circuit is configured to determine the bus collision event based at least in part on a communication bus current.

20. The control system of claim 16, wherein the one or more nodes of the plurality of nodes further comprises:
a transmit line operably coupling a transmit pin of the controller to the communication bus; and
a receive line operably coupling a receive pin of the controller to the communication bus,
wherein the transmit line is switched from a high impedance state to a transmit state based at least in part on the bus busy signal.
